(19) United States
(12) Patent Application Publication
(10) Pub. No.: US 2017/0261058 A1
(43) Pub. Date: Sep. 14, 2017

(54) ELEVATOR SAFETY SPRING AND METHOD OF MANUFACTURING

(71) Applicant: Otis Elevator Company, Farmington, CT (US)

(72) Inventors: Shihemn Chen, Bolton, CT (US); Joe J. Liou, South Windsor, CT (US); Andrzej Ernest Kuczek, Bristol, CT (US); Tahany Ibrahim El-Wardany, Bloomfield, CT (US); Xiaodong Luo, South Windsor, CT (US); David R. Polak, Glastonbury, CT (US); James M. Draper, Woodstock, CT (US); John J. Kriss, Manchester, CT (US); Duan Liang, Windsor, CT (US); Patricia L. O'Coin, Farmington, CT (US); Aayush Desai, New Britain, CT (US)

(21) Appl. No.: 15/451,833

(22) Filed: Mar. 7, 2017

Related U.S. Application Data
(60) Provisional application No. 62/306,934, filed on Mar. 11, 2016.

(51) Int. Cl. F16F 1/18; B33Y 80/00; B33Y 10/00; B66B 5/16; B21K 1/76

(52) U.S. Cl. CPC F16F 1/187; B66B 5/16; B21K 1/76; B33Y 10/00; B33Y 80/00; F16F 2226/04; F16F 2234/00

(57) ABSTRACT

A method of manufacturing an elevator safety spring is provided. The method includes determining a plurality of dimensional parameters of the elevator safety spring. The method also includes selecting a plurality of dimensions within the dimensional parameters. The method further includes manufacturing the elevator safety spring based on the selected parameters, the elevator safety spring having an I-beam cross-section.

### CROSS-REFERENCE TO RELATED APPLICATION

This patent application claims priority to U.S. Provisional Application Ser. No. 62/306,934, filed Mar. 11, 2016, which is incorporated herein by reference in its entirety.

### BACKGROUND OF THE DISCLOSURE

The embodiments herein generally relate to elevator safeties and, more particularly, to an elevator safety spring and methods of manufacturing elevator safety springs.

Elevator safety spring designs typically depend on the load on the safety and the maximum required deflection. Therefore, there is a need to use different spring size and thickness depending on the specific application. Commonly, safety springs have a substantially rectangular cross-section that is heated and bent to a desired geometry. When the thickness of the spring wall exceeds a certain dimension, the price of the material and increased tonnage of the forming equipment significantly increase the spring cost. Based on the number of different potential spring sizes and the bending manufacturing methods employed, numerous cumbersome steps and tools are associated with the manufacturing of the safety springs.

### BRIEF DESCRIPTION OF THE DISCLOSURE

According to one embodiment, a method of manufacturing an elevator safety spring is provided. The method includes determining a plurality of dimensional parameters of the elevator safety spring. The method also includes selecting a plurality of dimensions within the dimensional parameters. The method further includes manufacturing the elevator safety spring based on the selected parameters, the elevator safety spring having an I-beam cross-section.

In addition to one or more of the features described above, or as an alternative, further embodiments may include that manufacturing the elevator safety spring comprises forming the elevator safety spring with a die forging process.

In addition to one or more of the features described above, or as an alternative, further embodiments may include that manufacturing the elevator safety spring comprises an additive manufacturing process.

In addition to one or more of the features described above, or as an alternative, further embodiments may include that the additive manufacturing process comprises electron beam wire additive manufacturing.

In addition to one or more of the features described above, or as an alternative, further embodiments may include that the selected plurality of dimensions are optimized to provide predetermined spring characteristics of the elevator safety spring.

In addition to one or more of the features described above, or as an alternative, further embodiments may include that the predetermined spring characteristics are determined by a maximum load on a safety and a corresponding normal load applied to the elevator safety spring.

In addition to one or more of the features described above, or as an alternative, further embodiments may include that manufacturing the elevator safety spring comprises forming a single, unitary structure.

In addition to one or more of the features described above, or as an alternative, further embodiments may include that determining the plurality of dimensional parameters comprises performing a topology optimization analysis.

According to another embodiment, an elevator safety spring includes an I-beam cross-section having a plurality of variable dimensional parameters corresponding to a plurality of spring characteristics.

In addition to one or more of the features described above, or as an alternative, further embodiments may include that the elevator safety spring is a single, unitary structure.

In addition to one or more of the features described above, or as an alternative, further embodiments may include that the elevator safety spring is manufactured with an additive manufacturing process.

In addition to one or more of the features described above, or as an alternative, further embodiments may include that the additive manufacturing process comprises an electron beam wire additive manufacturing process.

In addition to one or more of the features described above, or as an alternative, further embodiments may include that the elevator safety spring is manufactured with a die forging process.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a perspective view of an elevator safety with an elevator safety spring associated therewith;

FIG. 2 is a perspective view of the elevator safety spring;

FIG. 3 is a perspective, cross-sectional view of the elevator safety spring;

FIG. 4 is an elevational, cross-sectional view of the elevator safety spring; and

FIG. 5 is an elevational, cross-sectional view of the elevator safety spring according to another aspect of the disclosure.

### DETAILED DESCRIPTION OF THE DISCLOSURE

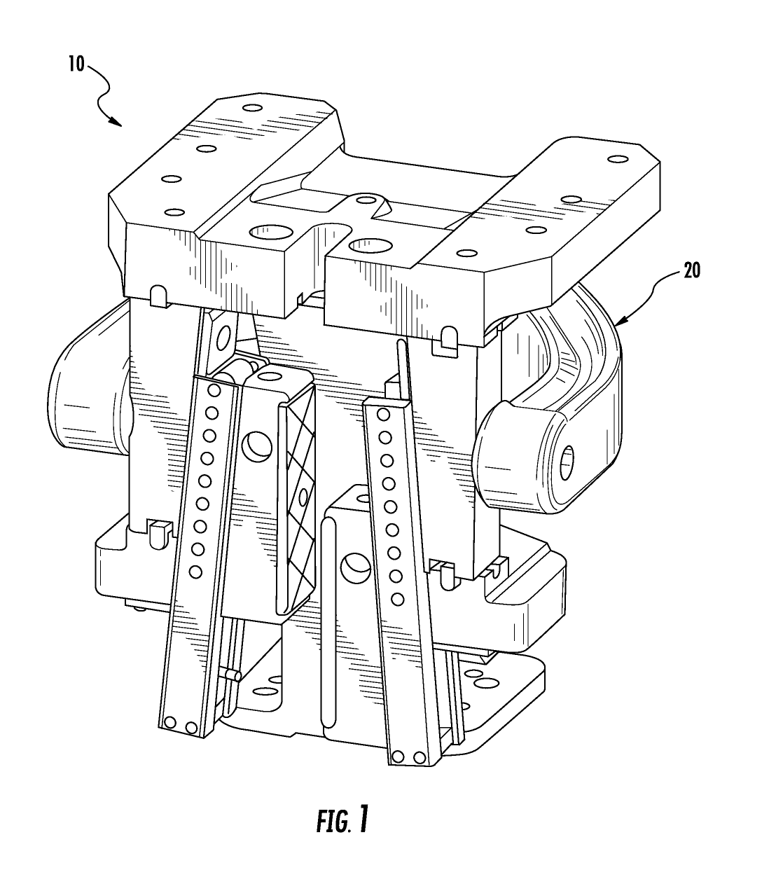

Referring to FIG. 1, an elevator safety 10 is illustrated with an elevator safety spring 20 associated therewith. The elevator safety 10 is actuated upon detection of an overspeed condition of an elevator car. Actuation of the elevator safety 10 results in gripping of a guide rail within a hoistway, with an increasing frictional force associated with such gripping sufficient to stop the elevator.

The elevator safety spring 20 is to provide a predetermined force that pushes safety wedges against the guide rail when the elevator safety 10 is fully engaged. This contact force generates frictional force to slow down the elevator at a desired deceleration rate.

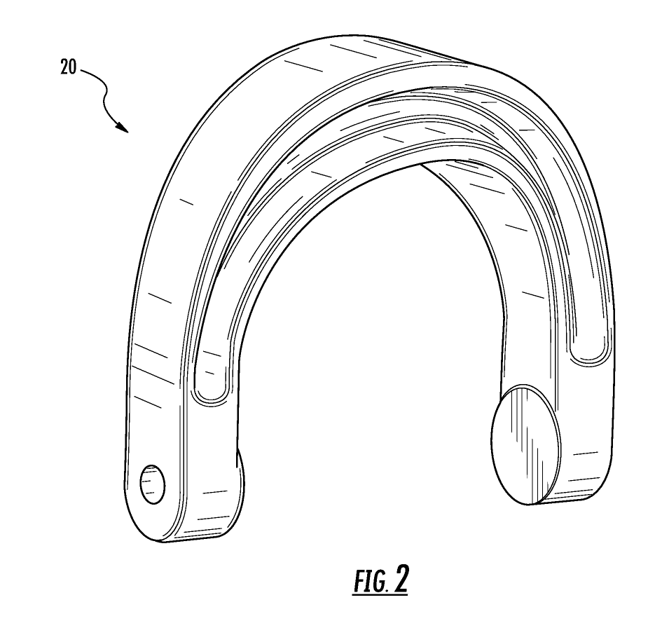

Referring now to FIG. 2, the elevator safety spring 20 is illustrated in greater detail. The elevator safety spring 20 has a generally U- shaped or C-shaped geometry. The elevator safety spring 20 is a single, unitary structure formed with a single manufacturing tool and/or setup. In some embodiments, the elevator safety spring 20 is formed of advanced high strength steel.

In one embodiment, a die forging manufacturing process is employed to form the elevator safety spring 20. In another embodiment, an additive manufacturing process is employed to form the elevator safety spring 20. An example of an additive manufacturing process is electron beam wire additive manufacturing or wire arc additive manufacturing (WAAM). The methods described above are merely illustrative and are not limiting of other suitable manufacturing processes.

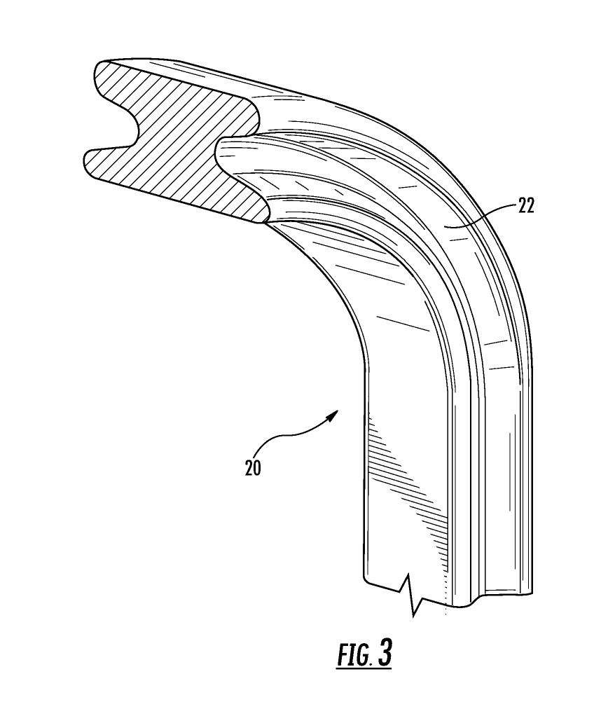

Referring to FIGS. 3-5, various portions of a spring body 22 are illustrated. The spring body 22 has a cross-sectional geometry substantially corresponding to an I-beam. The I-beam cross-section significantly reduces weight when compared to a substantially rectangular cross-sectioned safety spring.

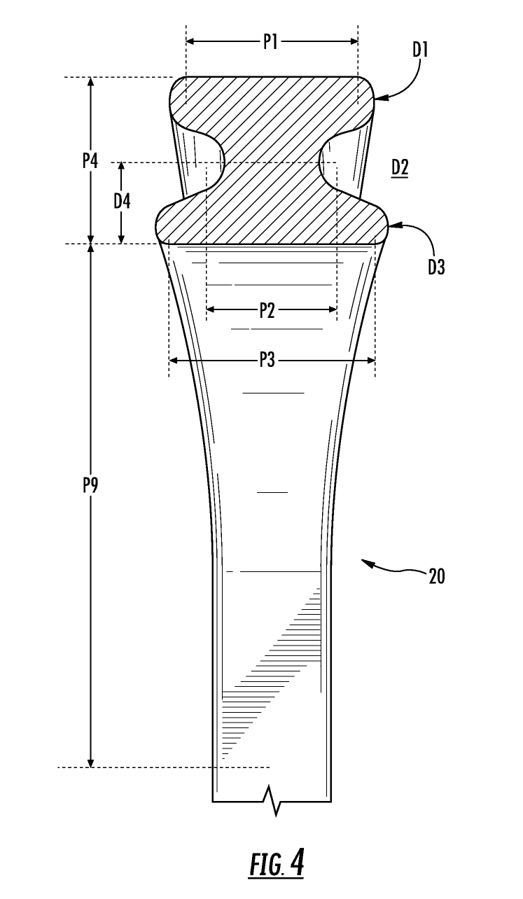

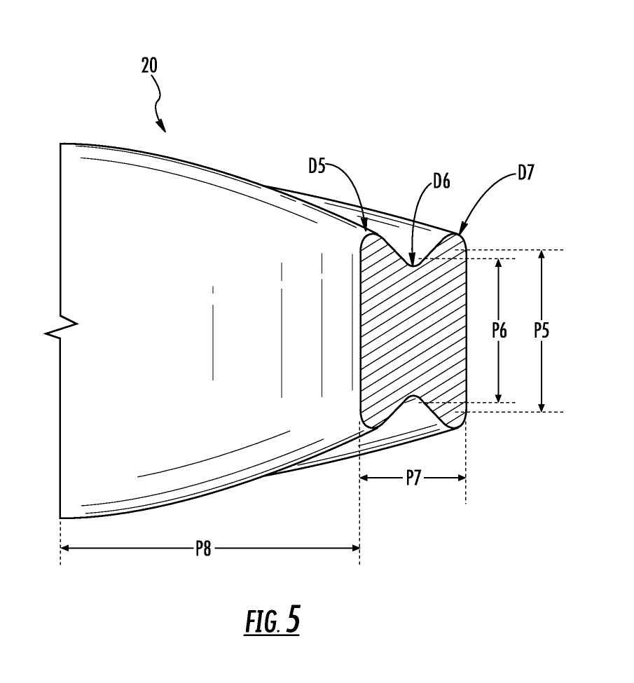

A method of manufacturing the elevator safety spring 20 is provided and includes a topology optimization analysis used to define a plurality of dimensional parameters of the elevator safety spring 20. The dimensional parameters may be varied to achieve a required spring deformation and to minimize the stresses on the elevator safety spring 20 to satisfy design requirements. The number of dimensional parameters may vary depending upon the particular application. In the illustrated embodiment shown in FIGS. 4 and 5, certain parameters are specifically referenced. In particular, various lengths and radii associated with the overall I-beam geometry have been determined to vary the spring characteristics in a predictable and analyzable manner. In some embodiments, the spring characteristics are determined by a maximum load on a safety and a corresponding normal load applied to the elevator safety spring 20. In the illustrated embodiment, 16 dimensional parameters have been shown, including six radii and ten lengths. It is to be understood that some or all of the illustrated dimensional parameters may be utilized in an optimization analysis.

In the illustrated embodiment, the parametric safety spring model is shown. Parameters P1-P9 are independent dimensional parameters comprising lengths and radii. P8 is determined by the safety loading locations and P9 is selected to avoid the interference between the spring and the safety block. P1-P7 are selected to meet other targets. D1-D7 are dependent dimensional parameters which are determined by the values of P1-P9.

Determining the dimensional parameters of the elevator safety spring 20 to be modified provides flexibility with respect to safety spring designs in a wide variety of applications. By unifying the elevator safety spring design and dimension, beneficial reductions in costs associated with tooling, fabrication and amortization are attained. This is based on elimination of the need for more than one tool or one setup. The use of an I-beam cross-section reduces the weight of the elevator safety spring, thereby enabling a reduced need and cost for ropes, counterweights and machine power required for overall operation of an elevator.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A method of manufacturing an elevator safety spring comprising:
determining a plurality of dimensional parameters of the elevator safety spring;
selecting a plurality of dimensions within the dimensional parameters; and
manufacturing the elevator safety spring based on the selected parameters, the elevator safety spring having an I-beam cross-section.

2. The method of claim 1, wherein manufacturing the elevator safety spring comprises forming the elevator safety spring with a die forging process.

3. The method of claim 1, wherein manufacturing the elevator safety spring comprises an additive manufacturing process.

4. The method of claim 3, wherein the additive manufacturing process comprises electron beam wire additive manufacturing.

5. The method of claim 1, wherein the selected plurality of dimensions are optimized to provide predetermined spring characteristics of the elevator safety spring.

6. The method of claim 5, wherein the predetermined spring characteristics are determined by a maximum load on a safety and a corresponding normal load applied to the elevator safety spring.

7. The method of claim 1, wherein manufacturing the elevator safety spring comprises forming a single, unitary structure.

8. The method of claim 1, wherein determining the plurality of dimensional parameters comprises performing a topology optimization analysis.

9. An elevator safety spring comprising an I-beam cross-section having a plurality of variable dimensional parameters corresponding to a plurality of spring characteristics.

10. The elevator safety spring of claim 9, wherein the elevator safety spring is a single, unitary structure.

11. The elevator safety spring of claim 9, wherein the elevator safety spring is manufactured with an additive manufacturing process.

12. The elevator safety spring of claim 11, wherein the additive manufacturing process comprises an electron beam wire additive manufacturing process.

13. The elevator safety spring of claim 9, wherein the elevator safety spring is manufactured with a die forging process.
